(19) United States
(12) Patent Application Publication
(10) Pub. No.: US 2002/0179021 A1
(43) Pub. Date: Dec. 5, 2002

(54) Reconfigurable modular play and exercise structure for animals

(76) Inventors: Monica DeRaspe-Bolles, Sammamish, WA (US); Barry G. Moore, Sammamish, WA (US)

Correspondence Address: BLACK LOWE & GRAHAM, 816 SECOND AVE., SEATTLE, WA, 98104, US

(21) Appl. No.: 09/872,231

(22) Filed: May 31, 2001

(51) Int. Cl. A01K 15/02

(52) U.S. Cl. 119/706

(57) ABSTRACT

A reconfigurable modular play structure for animals including a base, a plurality of multiple cylindrical support members, and one or more platforms to support an animal. The cylindrical support members are helically wrapped with a plurality of flexible line wrappings, allowing different colors and types of wrappings to be used in combination. Special access apertures and holes facilitate locking the line wrappings to the support members. One or more of the platforms may be rotated on swivel bearings, or an upper portion of the structure may be swiveled on a rotating connection. The structure may also include one or more play members held by an open spring or a soft flexible material playhouse for the entertainment of an animal.

### FIELD OF THE INVENTION

This invention relates generally to play and exercise structures for animals.

### BACKGROUND OF THE INVENTION

Cats and other pets enjoy climbing and elevated places where they can rest and observe goings on in their surroundings. Cats and other pets also enjoy and benefit from exercise involving movable objects and spaces that spark their natural curiosity and stalking and pouncing instincts, as well as provide them an opportunity to sharpen their claws.

A variety of structures and devices has been made for cats and other pets to satisfy these needs and instincts. Typical pet structures and devices for this purpose, however, are either very large and cumbersome, or limited to small scratching devices. Large freestanding animal structures, often constructed of wood with carpet covering, consist of long and heavy sidepieces. These large structures are cumbersome both for the pet owner to assemble and maintain, as well as for the retailer to acquire and stock for sale, especially given commercial limitations in the display space available in typical retail stores and outlets. Scratching and climbing structures and devices for pets have also been designed to attach to walls. Again, however, such devices are often large and cumbersome, and increase assembly complexity by requiring the pet owner to install wall fasteners and attach the device to a wall.

Attempts at workable animal structures have also suffered from a lack of flexibility in their configuration. Various attempts have been made to increase the flexibility and ease of use of such structures using detachable elements. Such attempts have been largely unsuccessful, however, due to manufacturing costs and design deficiencies.

Cats and other animals also enjoy and benefit from playing with paper bags and other flexible containers. Pet toys or attractive small objects or assemblages have often been hung by cord from pet structures and scratching devices. These accessories suffer from failure from use of the support cord, and shredding of the pet toy, often a toy mouse, with use. A more durably attached and durable in use accessory to an animal structure and scratching device would be desirable and useful.

Current play structures and perches provide only rigid structures and areas, rather than flexible ones that can be pushed through by the animal.

There is a need for a modular, reconfigurable structure that is attractive to and usable by cats and other animals, while providing ease of assembly, storage and maintenance both to pet owners and retailers.

### SUMMARY OF THE INVENTION

In accordance with the present invention, a modular, reconfigurable animal play and scratching structure is described. The present invention comprises a base member that rests upon a supporting surface and one or more cylindrical support members supporting one or more stationary or rotating platforms.

In accordance with further aspects of the invention, one or more of the platforms may be rotated after assembly through the use of swivel bearings above and below the platform. In a varied aspect of the invention, a rotating connector is used only below a platform to allow the entire portion of the play structure above the rotating connector to be rotated after assembly.

In accordance with other aspects of the invention, the cylindrical support members are multiple spirally wrapped with flexible line wrappings for animal scratching and climbing.

In accordance with still further aspects of the invention, both ends of the cylindrical support member have holes to anchor the ends of the multiple flexible line wrappings, which are spirally wrapped in parallel to cover the cylindrical structure member, as well as to provide color flexibility and a barber pole effect.

In accordance with still another aspect of the invention, the cylindrical support members at one or both ends are fitted with disk-shaped cheek plates that retain the flexible line wrappings close-wound around the cylindrical support member. In an alternative embodiment, the cylindrical support member cheek plates have one or more access apertures that permit access to the ends of the flexible line wrappings anchored through the holes at the ends of the cylindrical support members, facilitating locking the flexible line in place to prevent the ends from coming out of the holes through the support cylinders. In varying embodiments, locking the flexible line in place is done with knots, clamps or clips.

In accordance with yet another aspect of the invention, one or more of the supporting platforms is specially shaped, such as scalloped disc shaped, paddle-shaped, fish-shaped, or dog bone-shaped.

In accordance with yet another aspect of the invention, two platforms are assembled with a cylindrical support member, one above another, and an enclosed area defining a playhouse is created by hanging a soft flexible material from the upper platform toward the lower platform. In varying embodiments, the soft flexible material may be plastic or fabric pieces or strips. In accordance with yet a further aspect of the invention, the fabric playhouse is configured to have one or more door-shaped openings. In an alternative embodiment, the playhouse materials are hung from a platform situated immediately above the base, and the enclosed area is between the platform and the base.

In accordance with a further aspect of the invention, a shaped play member is attached to one of the cylindrical support members or platforms via a spring. The spring and play member projects outward from the support members or down from the platforms. The play member will then bounce when the cat or other animal bats at it. In other aspects of the invention, the play member is a ball and is covered with a shaggy carpet material.

As will be readily appreciated from the foregoing summary, the invention includes small modular sections for an animal play structure that provides durability and flexibility in configuration after assembly. It further provides optional elements including rotating platforms, specially shaped platforms, multiple color choices and color combinations for spiral wrapping of the scratching and support members, an animal playhouse, and shaped play members.

### BRIEF DESCRIPTION OF THE DRAWINGS

The many features and advantages of this invention are better understood with reference to the following detailed description, along with the following drawings.

FIG. 1 is an isometric view of a play structure for animals in accordance with the present invention illustrating a plurality of cylindrical support members, a base, a plurality of platforms, multiple spiral flexible line wrappings on the cylindrical support members, and a top fastener.

FIG. 2 is a side view of the play structure showing a rotating connector permitting reconfiguration of the structure.

FIG. 3 is an exploded isometric view showing the components of the play structure of FIG. 2.

FIG. 4 is an isometric view of the disassembled play structure of FIG. 2 showing the small size of the components closely packed for retailing or storage.

FIG. 5 is an enlarged exploded section taken substantially along the plane of the line 5-5 of FIG. 1.

FIG. 6 is an enlarged exploded section taken substantially along the plane of line 6-6 in FIG. 2.

FIG. 7 is an enlarged exploded section of an alternative embodiment of the present invention having two swivel bearings permitting reconfiguration of a single platform of the structure.

FIG. 8 is an isometric view of the play structure for animals, illustrating a plurality of material-covered shaped play members movably attached to the structure.

FIG. 9 is an isometric view of the play structure for animals, further showing a soft flexible material playhouse.

### DETAILED DESCRIPTION OF THE PREFERRED EMBODIMENT

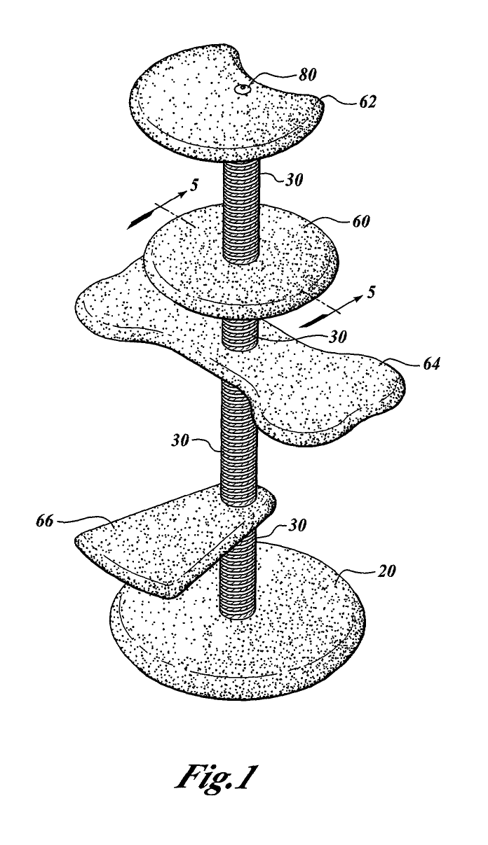

Referring to FIG. 1, the play structure for animals comprises a base 20 removably fastened to one or more multiple spiral wrapped cylindrical support members 30, and one or more platforms 60. Platforms 60 may be specially shaped. Examples of design variations include paddle shaped 66, dog bone shaped 64, scalloped disk shaped 62, and fish shaped (not shown) platforms. It will be appreciated that while only a limited number of platform designs are shown and described herein, the platforms may be specially shaped to incorporate a virtually limitless number of design variations. The multiple spiral wrapped cylindrical support members are releasably fastened end to end forming a pole with two ends, the lower end fastened to base 20, and the upper end capped with a securing fastener 80.

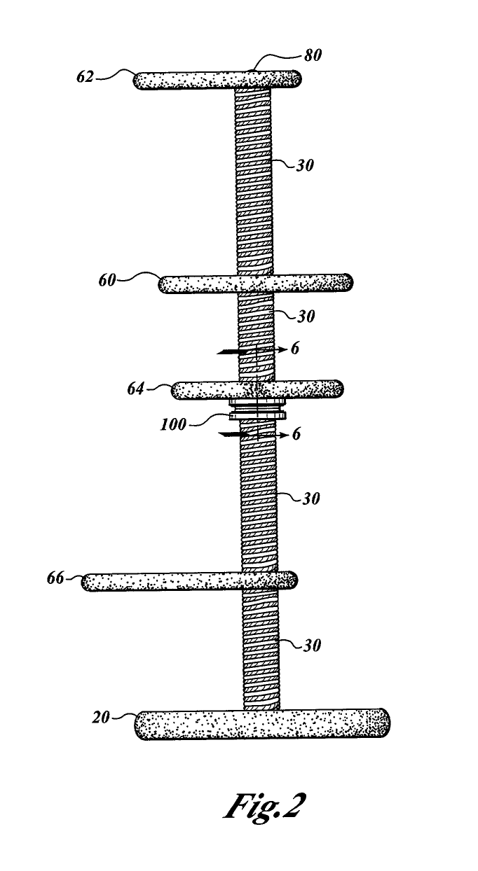

As shown in FIG. 2, an alternate embodiment of the play structure further comprises a rotating connector 100 releasably connected between an upper end of a multiple spiral wrapped cylindrical support member 30 and a platform 60. The rotating connector permits an upper portion of the animal play structure, above the rotating connector, to be rotatably reconfigured relative to a lower portion of the animal play structure.

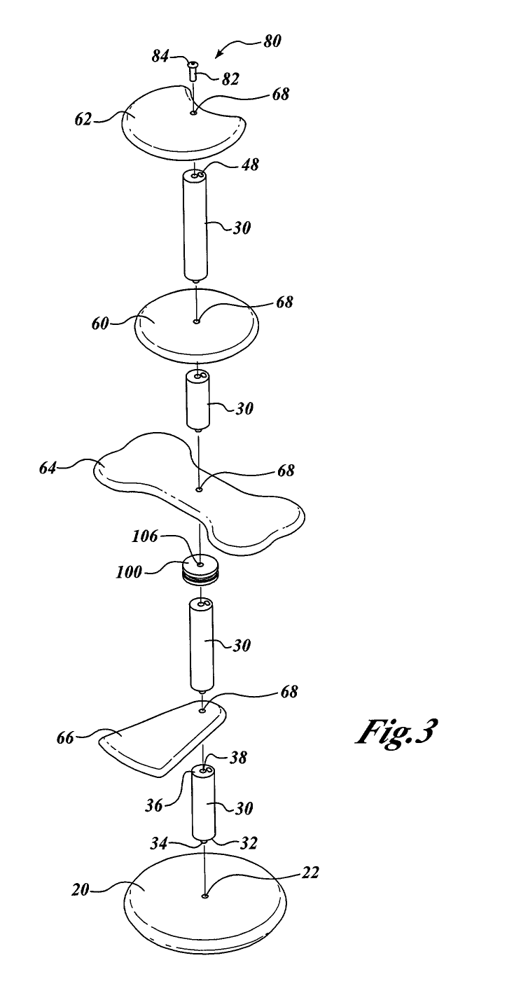

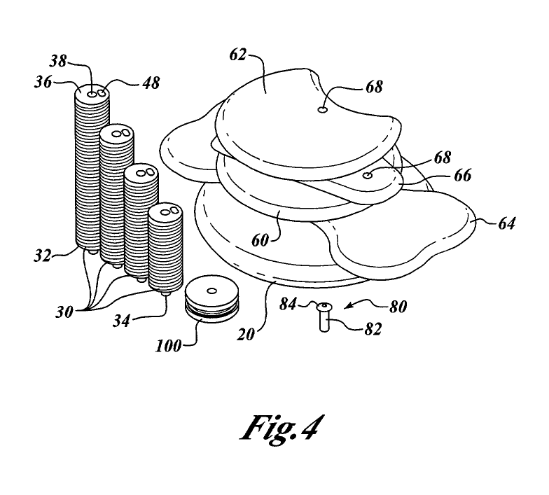

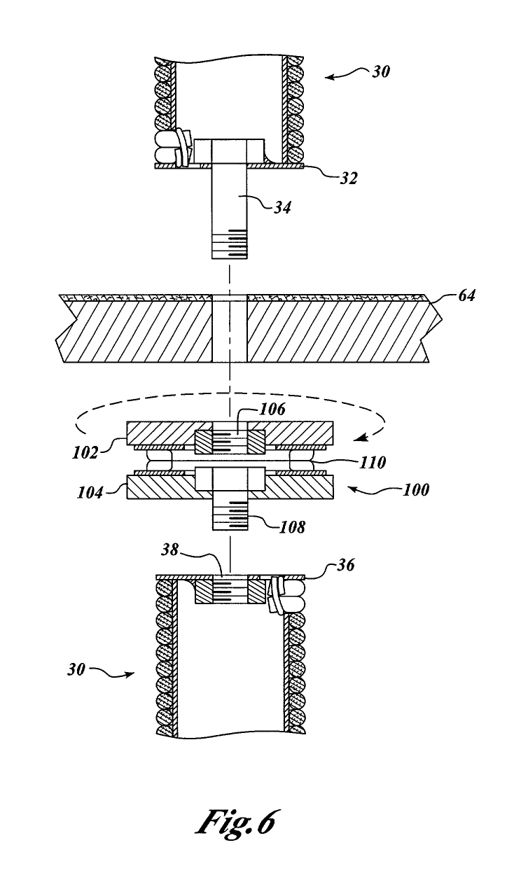

As further shown with reference to FIGS. 3 and 4, the present invention is comprised of small component parts releasably connected to facilitate convenient packing, transportation, retail display and sale, and customer storage. In the preferred embodiment, base 20 includes a female threaded connector 22. Each multiple spiral wrapped cylindrical support member 30 includes affixed end pieces 32 and 36, one located on each end of the support member. A male threaded connector 34 is attached to end piece 32, and a female threaded connector 38 is attached to end piece 36. Male threaded connector 34 is threaded and sized to correspond to and be received by female threaded connector 38 of support member 30, as well as by female threaded connector 22 of base 20. End pieces 32 and 36 further include access apertures 48, described with more particularity below. Platforms 60 include assembly holes 68, sized to allow passage of male threaded connector 34. Alternatively, platforms 60 may include a cutout (not shown) rather than an assembly hole, the cutout sized slightly larger than the diameter of the support member end pieces. This embodiment allows a first support member to pass completely through the platform to join with a second support member or base 20. Rotating connector 100 (see also FIG. 6) comprises a male threaded connector 108 and a female threaded connector 106 threaded and sized to correspond to and be connected with, respectively, female threaded connector 38 and male threaded connector 34 of support members 30. Securing fastener 80 consists of a male threaded portion 82 threaded and sized to correspond to and be received by female threaded connector 38 of support member 30, as well as by female threaded connector 22 of base 20. One end of the securing fastener, designed to be exposed where not threaded into female threaded connector corresponding to the male threaded portion of the securing fastener, further includes a smooth and generally flat or slightly rounded cap 84. The cap may be configured to receive a screwdriver or wrench assembly to allow tightening of the securing fastener in the female threaded connector.

During assembly, for example of the embodiment shown in FIG. 3, male threaded connector 34 of a first support member 30 is threadably inserted into female threaded connector 22 of base 20. Assembly hole 68 of paddle shaped platform 66 is aligned with female threaded connector 38 of first support member 30. Male threaded connector 34 of a second support member 30 is then passed through assembly hole 68 of paddle shaped platform 66 and threadably inserted into female threaded connector 38 of first support member 30. To permit rotatable reconfiguration of the support members and platforms located above this point of the structure, rotating connector 100 is placed between dog bone shaped platform 64 and second support member 30, as described in greater detail below (see FIG. 6). Assembly hole 68 of dog bone shaped platform 64 is aligned with the rotating connector and female threaded connector 38 of second support member 30. Male threaded connector 34 of a third support member 30 is then passed through assembly hole 68 of dog bone shaped platform 64 and into rotating connector 100, which in turn is threadably connected via female threaded connector 38 to second support member 30. This general process is repeated for circular platform 60, a fourth support member 30, and scalloped disk shaped platform 62. The assembled structure is capped by passing male threaded portion 82 of securing fastener 80 through assembly hole 68 of scalloped disk shaped platform 62 and threadably inserting the male threaded portion into the female threaded connector. By tightly connecting male threaded connector 34 with corresponding female threaded connector 38, end pieces 32 and 36 securely engage platform 60. In an alternate embodiment, multiple adjacent support members are threadably connected directly without a sandwiched platform, making a longer pole between other platforms, or the base and a platform.

Referring to FIG. 4, the component parts of the animal play structure are displayed in disassembled isometric form showing the capability of the animal play structure to be packed or stored in a small space. FIG. 4 shows the animal play structure comprising base 20, a plurality of multiple spiral wrapped cylindrical support members 30 each with two opposite end pieces 32 and 36, end piece 32 having male threaded connector 34 and access aperture 48 (not visible) and end piece 36 having female threaded connector 38 and access aperture 48. The structure has a plurality of platforms 60 of various shapes, which include scalloped disk shaped platform 62, paddle shaped platform 66, circular platform 60, and dog bone shaped platform 64. FIG. 4 shows the disassembled and closely packed components of the embodiment shown in FIG. 2, including rotating connector 100, and a securing fastener 80.

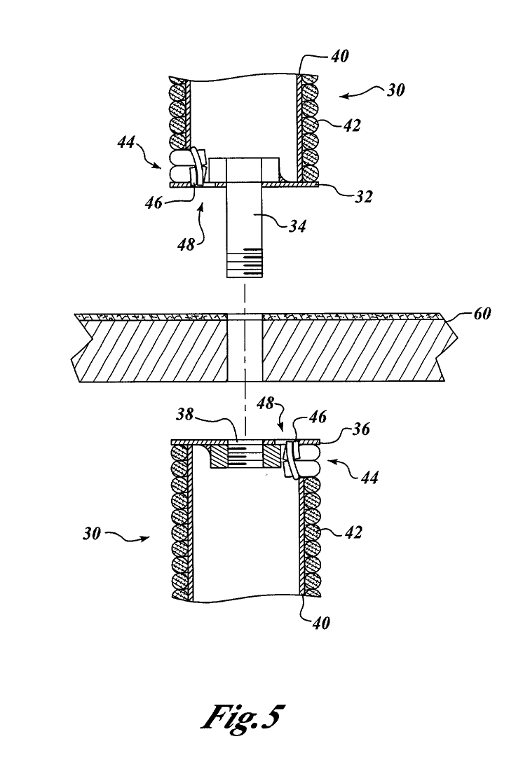

FIG. 5 is a cross section showing adjacent multiple spiral wrapped cylindrical support members 30 having a platform 60 sandwiched between. Attached at the end of each multiple spiral wrapped cylindrical support member is an end piece 32 or 36, supporting male threaded connector 34 and female threaded connector 38, respectively. In the preferred embodiment, end pieces 32 and 36 are cheek plates, and the male and female threaded connectors are securely mounted to or formed into the cheek plates. As described above, male threaded connector 34 is threaded and sized to correspond to and be received by female threaded connector 38. In the preferred embodiment, the multiple spiral wrapped cylindrical support members are hollow cylinders, preferably made out of metal, having thin walls 40. In alternative embodiments of the invention the support members may be solid, or thick walled, and the end pieces may be integral with the support members.

As shown more particularly with reference to FIG. 5, support members 30 include multiple flexible line wrappings 42. The multiple flexible line wrappings preferably consist of two pieces of rope close-wound around support member wall 40. The ends of the multiple flexible line wrappings project through line holes 44 in the side of support member wall 40 adjacent to the ends of the support member. The flexible line wrappings originate in a first line hole at one end of the support member and are close wound in spiral fashion around the support member wall to the other end of the support member, at which point they are projecting through a second line hole at the other end of the support member. In the preferred embodiment, the flexible line wrappings are locked in place at their ends with a metal fastener 46, which may be crimped through access aperture 48. Other fasteners may be used, including knots, glue, etc. In alternative embodiments of the invention, line hole 44 may take different forms, such as a notch at the ends of the support member or multiple holes or notches, one for each corresponding line wrapping, at different angles around the support member. Line wrappings may also be terminated at different locations along length of the support member.

In the preferred embodiment, the diameter of end pieces 32 and 36 are equal to the diameter of the support member wall 40, plus the diameter of the flexible line wrappings spirally close-wound around the support member wall. In alternative embodiments, the diameter of the end pieces may vary and be less than or greater than the diameter of the support member wall. Increasing the size of the end pieces provides greater support to sandwiched platform 60.

FIG. 6 is an enlarged section taken substantially along the plane of line 6-6 on FIG. 2. This figure shows an alternate embodiment of the animal play structure having a rotating connector 100 that permits an upper portion of the play structure to be rotationally reconfigured relative to a lower portion. Rotating connector 100 includes movable attached but independently rotatable upper and lower swiveling members 102 and 104, respectively. Upper swiveling member 102 has a female threaded connector 106, threaded and sized to receive the male threaded connector 34 of a support member. Lower swiveling member 104 has a male threaded connector 108 threaded and sized to be received by the female threaded connector 38 of a support member. The upper and lower swiveling members rotate on a race of ball bearings 110. Rotating connector 100 preferably has a diameter equal to or larger than the diameters of end pieces 32 and 36 to engage and provide support to the platform or the adjacently attached multiple spiral wrapped cylindrical support members 30.

In assembly, to permit rotatable reconfiguration of the support members and platforms located above this point of the structure, rotating connector 100 is placed between platform 60 and support member 30. More specifically, assembly hole 68 of platform 60 is aligned with female threaded connector 106 of upper swiveling member 102. Male threaded connector 34 of a first supporting member is then passed through assembly hole 68 of platform 60 and threadably connected to female threaded connector 106. Male threaded connector 108 of lower swiveling member 104 is threadably connected to female threaded connector 38 of a second support member. In an alternative embodiment, two multiple spiral wrapped cylindrical support members 30 are attached directly to rotating connector 100 without platform 60 sandwiched in between. In yet an alternative embodiment (not shown), two rotating connectors 100 are used, one adjacent to the top and bottom surfaces of a platform, respectively. In this configuration, the individual platform surrounded by adjacent rotating connectors is rotatable independent of the balance of the structure, and the upper portion of the structure is rotatable independent of the lower portion of the structure.

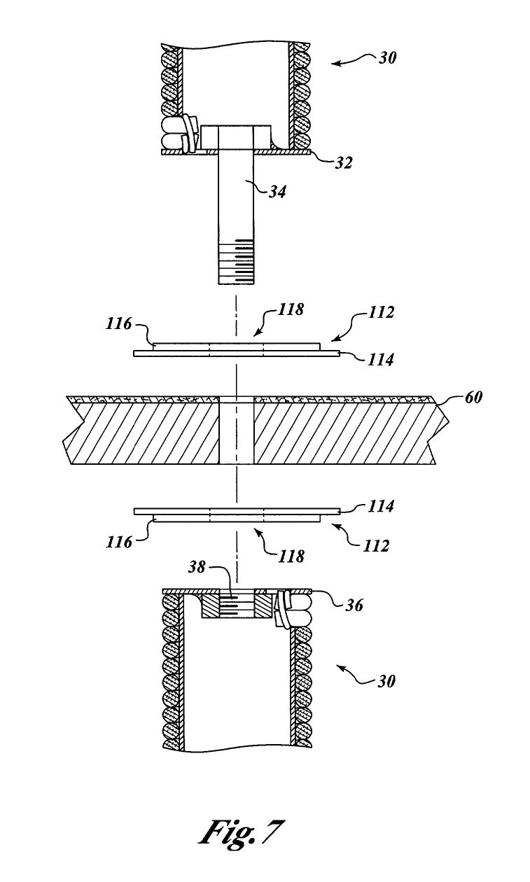

FIG. 7 is an enlarged cross section showing an alternate embodiment of the present invention using a different type of rotating connection. In this embodiment, swivel bearings 112 are thin, comprised of a faceplate 114 and a bearing surface 116 in which bearings (not shown) are maintained. Swivel bearing 112 further includes a center aperture 118 sized to allow passage of male threaded connector 34 of support members 30.

In assembly, first and second swivel bearings 112 are placed above and below platform 60 and between first and second support members 30. In this embodiment, assembly hole 68 of platform 60 is aligned with center aperture 118 of both swivel bearings 112. Male threaded connector 34 of a first supporting member is then passed through center aperture 118 of the first swivel bearing, through assembly hole 68 of platform 60 and through center aperture 118 of a the second swivel bearing, to be threadably connected to female threaded connector 38 of the second support member. Inclusion of two swivel bearings, each have independently movable bearings, permits a single platform 60 to be rotationally reconfigured relative to the balance of the animal play structure.

In an alternative embodiment, a swivel bearing assembly is used in association with a platform 60 having a cutout rather than an assembly hole, the cutout sized slightly larger than the diameter of the end piece of the first supporting member, a ring-shaped swivel bearing 112, and an additional support element (not shown) having an assembly hole sized to allow passage of the male threaded connector. In this embodiment, the additional support element is placed above female threaded connector 38, resting on end piece 36 of the second support member. Bearing surface 116 is attached (permanently or removably) to the additional support element. Faceplate 114 is attached (permanently or removably) to platform 60. The first support member is passed through the cutout in the platform and the ring-shaped swivel bearing so that end piece 36 of the first support member rests on the additional support element. Male threaded connector 34 is passed through platform 60, the ring-shaped swivel bearing, and the additional support element (via the assembly hole) and threadably connected to female threaded connector 38. This embodiment allows only single platform 60 to rotate independent from the balance of the structure.

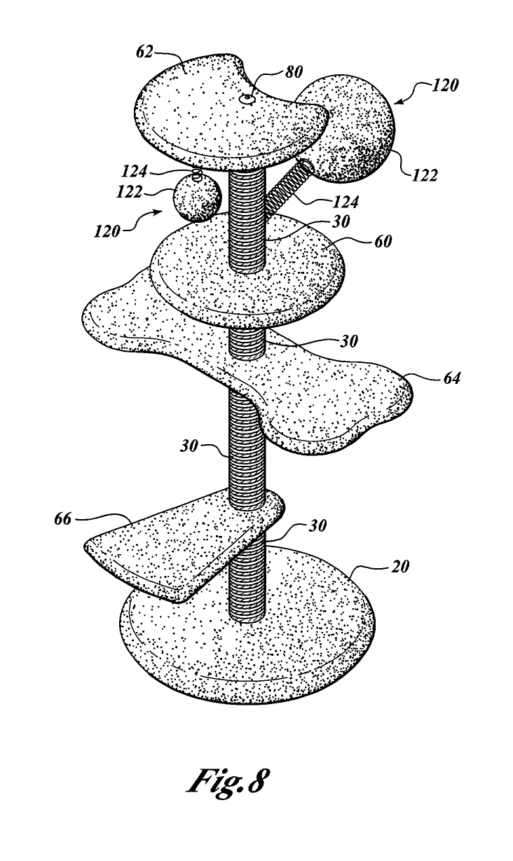

FIG. 8 shows an alternative embodiment of the invention including two material covered members 120 attached to the modular play structure for animals. In this embodiment, the members are ball shaped, and are covered with a shaggy carpet material. In other embodiments alternative shapes as well as alternate covering materials for scratching or clawing by a cat or other animal may be utilized. In the preferred embodiment, material covered members 120 comprise of a carpet-covered ball 122 removably fastened to one end of an open spring 124. The opposite end of the spring from the ball is removably fastened to multiple spiral wrapped cylindrical support member 30 of the animal play structure. FIG. 8 also shows an alternate embodiment where material covered member 122 is removably fastened to an open spring 124 that is removably fastened to the underside of platform 60 of the animal play structure. Play member 120 may be fastened to the play structure in a wide variety of ways, either to support members or platforms, as well as at various angles relative to the vertical support members, dependent on the resiliency of spring 124 and the size and weight of ball 122.

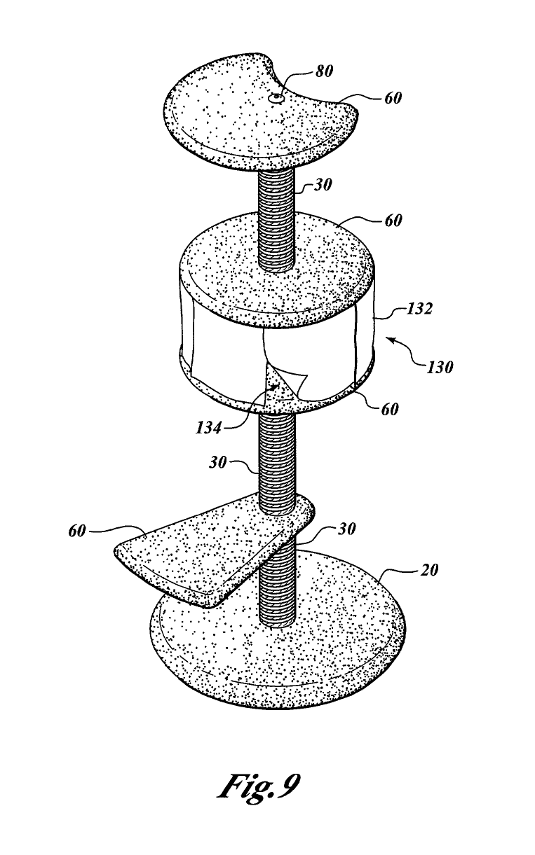

FIG. 9 shows an alternate embodiment of the invention with a playhouse 130 for the modular play structure for animals. The playhouse comprises a soft flexible material 132, in one or more pieces, releasably or permanently attached to platform 60 (for instance by Velcro, snaps, string, hooks, nails, glue, etc.) so as to drape or hang down from the supporting platform towards the platform below, forming an enclosed area 134. In an alternate embodiment, playhouse 130 is located on the first platform above base 20 and soft flexible material 132 hangs down from the platform touching or coming near the base. Soft flexible material 132 may consist of strips of any number of various materials, such as fabrics, carpets, leathers, etc. The configuration of the resulting enclosed area may vary based on the flexibility of material 132 used, as well as on the shape of platform 60 to which the material is attached. Ingress and egress paths into the enclosed area may be added, such as an opening shaped like a doorway cut into material 132. In yet alternative embodiments, different enclosed areas could be defined by either flexible or rigid coverings positioned on or supported by the supporting members, platforms, or the base. The playhouse may also be made with wire or framed with wire, further enclosed by a covering material. For example, a playhouse may be framed above and below by one or more platforms or the base and molded wire spanning between the platform and base. This structure could be enclosed by flexible or semi-rigid materials draped or molded around part or all of the wire frame to create a play enclosure. Ingress and egress paths could be added to this structure.

While the preferred embodiment of the invention has been illustrated and described, as noted above, many changes can be made without departing from the spirit and scope of the invention. For example, the orientation of male and female threaded connectors on the end pieces of the support members may be reversed, the base female threaded connector converted to a male threaded connector, and the securing fastener modified to receive a male threaded connector. This would allow assembly of a comparable structure within the scope of the present invention. Alternately, locking peg and socket connectors could be substituted for threaded connectors. The supporting columns, cylinders in the preferred embodiment herein may also be other shapes in cross section, including square, oval, or rectangular. Materials other than metal may be utilized for the cylindrical support members. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A modular play structure for animals, positionable upon a support surface, comprising:
a base engageable with the support surface;
at least one elongated cylindrical support member having an upper end and a lower end, the support member helically wrapped with at least one flexible line wrapping close-wound around the cylindrical support member between its upper and lower ends, the lower end of the support member being removably attached to the base; and
at least one platform removably attached to the upper end of the at least one cylindrical support member.

2. The modular play structure of claim 1, wherein the lower end of the at least one elongated cylindrical support member is removably attached to the base with threaded connectors.

3. The modular play structure of claim 1, wherein the upper end of the at least one elongated cylindrical support member is removably attached with threaded connectors.

4. The modular play structure of claim 1, wherein
the upper end of the at least one elongated cylindrical support member includes a threaded female receptacle;
the lower end of the at least one elongated cylindrical support member includes a threaded male extension;
the base includes a threaded female receptacle threaded and sized to receive the threaded male extension of the lower end of the elongated cylindrical support member; and
the threaded male extension of the lower end of the elongated cylindrical support member is releasably attached to the threaded female receptacle of the base.

5. The modular play structure of claim 1, wherein
the lower end of the at least one elongated cylindrical support member includes a threaded female receptacle;
the upper end of the at least one elongated cylindrical support member includes a threaded male extension;
the base includes a threaded male extension threaded and sized to thread into the threaded female receptacle of the lower end; and
the threaded female extension of the lower end is releasably attached to the threaded male extension of the base.

6. The modular play structure of claim 1, further comprising a plurality of platforms.

7. The modular play structure of claim 1, further comprising a plurality of cylindrical support members.

8. The modular play structure of claim 1, wherein the support member is helically wrapped with a plurality of flexible line wrappings close wound around the cylindrical support member, the plurality of flexible line wrappings comprising alternating types of rope.

9. The modular play structure of claim 8, wherein the elongated cylindrical support member is a thin walled cylinder, the thin walled cylinder has at least one hole at the upper and lower ends, and where the plurality of flexible line wrappings close-wound around the elongated cylindrical support member are threaded through the holes at the upper and lower ends of the thin walled cylinder and held inside the elongated cylindrical support member.

10. The modular play structure of claim 9, wherein the elongated cylindrical support member further comprises two disk-shaped cheek plates, each with a center and a perimeter, attached to each of the opposite ends of the thin walled cylinder, each cheek plate having a diameter equal to or greater than the diameter of the thin walled cylinder plus the diameter of the flexible line wrappings helically close-wound around the elongated cylindrical support member, the cheek plates penetrated by one or more access apertures located away from the center of the cheek plate, and inside the perimeter of the cheek plate, allowing access to the ends of the flexible line wrappings threaded through the holes at the ends of the thin walled cylinder for holding the flexible line wrappings to the thin walled cylinder.

11. The modular play structure of claim 1, wherein the platform has the shape of a paddle, and the assembly hole is located at the narrow end of the paddle.

12. The modular play structure of claim 1, wherein the platform has the shape of a fish.

13. The modular play structure of claim 1, wherein the platform has the shape of a dog bone.

14. The modular play structure of claim 1, further comprising a rotating connector, releasably attached to the modular play structure to permit a portion of the structure above the rotating connector to be rotated separate from a portion of the structure below the rotating connector.

15. The modular play structure of claim 14, further comprising a plurality of rotating connectors, releasably attached to the modular play structure to permit a plurality of portions of the structure to be rotated independent from a plurality of different portions of the structure.

16. The modular play structure of claim 1, wherein removably fastened immediately above the platform is an upper swivel bearing and removably fastened immediately below the platform is a lower swivel bearing, permitting the platform to rotate when assembled.

17. The modular play structure as in claim 1, further comprising a material covered member removably fastened on one end of an open spring, the open spring having another end away from the material covered member removably fastened to the modular play structure.

18. The modular play structure of claim 17, wherein the member comprises a ball.

19. The modular play structure of claim 17, wherein the member is covered with material comprising a shaggy carpet material.

20. The modular play structure of claim 1, further comprising a playhouse having one or more pieces of soft flexible material attached to the platform hanging from the outside shape of the platform extending downward to the base and forming an enclosed area.

21. The modular play structure of claim 20, further comprising a doorway shaped aperture in the soft flexible material.

22. A play structure for animals, positionable upon a support surface, comprising:
a base engageable with the support surface;
at least one elongated support member having an upper end and a lower end, the lower end of the support member attached to the base to hold the support member above the base;
at least one platform attached to the upper end of the support member; and
a playhouse comprising one or more pieces of soft flexible material attached to the platform hanging from the outside shape of the platform extending downward to the base, forming an enclosed area substantially surrounded by the soft flexible material.

23. A play structure for animals, positionable upon a support surface, comprising:
a base engageable with the support surface;
at least one elongated support member having an upper end and a lower end, the lower end of the support member attached to the base to hold the support member above the base;
at least one platform attached to the upper end of the support member; and
a material covered member fastened on one end of an open spring, the open spring having another end away from the material covered member fastened to the play structure.

24. A play structure for animals, positionable upon a support surface, comprising:
a base engageable with the support surface;
at least one elongated support member having an upper end and a lower end, the lower end of support member attached to the base to hold the support member substantially perpendicular to the base, wherein the support member is helically wrapped with a plurality of flexible line wrappings close wound around the support member; and
at least one platform attached to the upper end of the support member.

25. A play structure for animals, positionable upon a support surface, comprising:
a base engageable with the support surface;
at least one elongated support member having an upper end and a lower end, the lower end of the support member attached to the base to hold the support member above the base;
at least one platform attached to the upper end of the support member; and
a rotating connector, releasably attached to the modular play structure to permit a portion of the structure above the rotating connector to be rotated separate from a portion of the structure below the rotating connector.

26. A play structure for animals, positionable upon a support surface, comprising:
a base engageable with the support surface;
at least one elongated support member having an upper end and a lower end, the lower end of the support member attached to the base to hold the support member above the base;
at least one platform attached to the upper end of the support member; and
a plurality of rotating connectors, releasably attached to the modular play structure to permit a plurality of portions of the structure to be rotated independent from a plurality of different portions of the structure.

27. A modular play structure for animals, positionable upon a support surface, comprising:
a base engageable with the support surface;
a plurality of elongated cylindrical support members, each having an upper end and a lower end, each support member helically wrapped with a plurality of flexible line wrapping close-wound around the cylindrical support members between their upper and lower ends, the cylindrical support members being removably attached to each other end to end to form a column with a top and bottom end, the bottom end of the column being removably attached to the base to hold the support members above the base; and
a plurality of platforms removably attached to the upper ends of cylindrical support members.

28. A modular play structure for animals, positionable upon a support surface, comprising:
a base engageable with the support surface;
a plurality of elongated cylindrical support members having an upper end and a lower end, the support members helically wrapped with a plurality of flexible line wrapping close-wound around the cylindrical support members between their upper and lower ends, the cylindrical support members being removably attached to each other end to end to form a column with a top and bottom end, the bottom end of the column being removably attached to the base to hold the support members above the base;
a plurality of platforms removably attached to the upper ends of cylindrical support members; and
an upper swivel bearing removably fastened immediately above one platform and a lower swivel bearing removably fastened immediately below the platform, permitting the platform to rotate independent of the balance of the structure.

29. A modular play structure for animals, positionable upon a support surface, comprising:
a base engageable with the support surface;
a plurality of elongated cylindrical support members having an upper end and a lower end, the support members helically wrapped with a plurality of flexible line wrapping close-wound around the cylindrical support members between their upper and lower ends, the cylindrical support members being removably attached to each other end to end to form a column with a top and bottom end, the bottom end of the column being removably attached to the base to hold the support members perpendicular to the base;
a plurality of platforms removably attached to the upper ends of cylindrical support members;
an upper swivel bearing removably fastened immediately above one platform and a lower swivel bearing removably fastened immediately below the platform, permitting the platform to rotate independent of the balance of the structure;
a playhouse comprising one or more pieces of soft flexible material attached to a platform hanging from the outside shape of the platform extending downward to the base or a lower platform, forming an enclosed area surrounded by the soft flexible material; and
a material covered member removably fastened on one end of an open spring, the open spring having another end away from the material covered member removably fastened to the modular play structure.
